(19) United States
(12) Patent Application Publication
(10) Pub. No.: US 2013/0124695 A1
(43) Pub. Date: May 16, 2013

(54) Mobility Device Method

(71) Applicants: Peter Bookman, Draper, UT (US); Rick Charles White, Salt Lake City, UT (US); Michael Anderer, Salt Lake City, UT (US)

(72) Inventors: Peter Bookman, Draper, UT (US); Rick Charles White, Salt Lake City, UT (US); Michael Anderer, Salt Lake City, UT (US)

(21) Appl. No.: 13/722,720

(22) Filed: Dec. 20, 2012

Related U.S. Application Data
(63) Continuation of application No. 13/491,455, filed on Jun. 7, 2012, now abandoned.
Application No. 13/491,455 is a continuation of application No. 13/304,200, filed on Nov. 23, 2011, now abandoned.
Application No. 13/304,200 is a continuation-in-part of application No. 12/121,690, filed on May 15, 2008, now abandoned.
Application No. 12/121,690 is a continuation of application No. 10/954,533, filed on Sep. 29, 2004, now abandoned.
(60) Provisional application No. 60/507,197, filed on Sep. 29, 2003.
(60) Provisional application No. 60/506,918, filed on Sep. 29, 2003.
(60) Provisional application No. 60/506,919, filed on Sep. 29, 2003.
(60) Provisional application No. 60/506,925, filed on Sep. 29, 2003.
(60) Provisional application No. 60/543,735, filed on Jan. 22, 2004.
(60) Provisional application No. 60/538,763, filed on Jan. 22, 2004.
(60) Provisional application No. 60/538,915, filed on Jan. 22, 2004.
(60) Provisional application No. 60/538,767, filed on Jan. 22, 2004.

(51) Int. Cl. G06F 15/16

(52) U.S. Cl. CPC G06F 15/16
USPC 709/219

(57) ABSTRACT

A mobility device search client operative to perform searches across disparate computing environment, and an upgrade module operative to allow at least one upgrade of a computing application is provided. In an illustrative implementation, a mobility device comprises at least one search client or upgrade computing application that is operative with a plurality of computing environments.

### CROSS-REFERENCE TO RELATED APPLICATIONS

This application is a continuation application of U.S. patent application Ser. No. 13/491,455, filed on Jun. 7, 2012 (which is hereby incorporated by reference in its entirety), which is a continuation of U.S. application Ser. No. 13/304,200 filed Nov. 23, 2011 (hereinafter, the “direct parent application”). This direct parent application is a continuation-in-part application of U.S. patent application Ser. No. 12/121,690 filed May 15, 2008, which is a continuation of U.S. patent application Ser. No. 10/954,533, which application claims the benefit of the following U.S. Provisional Patent Applications: 60/507,197, filed on Sep. 29, 2003; 60/506,918, filed on Sep. 29, 2003; 60/506,919, filed on Sep. 29, 2003; 60/506,925, filed on Sep. 29, 2003; 60/543,735, filed on Jan. 22, 2004; 60/538,763, filed on Jan. 22, 2004; 60/538,915, filed on Jan. 22, 2004; and 60/538,767, filed on Jan. 22, 2004, which are hereby incorporated by reference in their entirety.

The direct parent application is also a continuation-in-part application of U.S. patent application Ser. No. 12/369,602 filed Feb. 11, 2009, which is a continuation of U.S. patent application Ser. No. 10/954,498, filed on Sep. 29, 2004, which application claims the benefit of the following U.S. Provisional Patent Applications: 60/507,197, filed on Sep. 29, 2003; 60/506,918, filed on Sep. 29, 2003; 60/506,919, filed on Sep. 29, 2003; 60/506,925, filed on Sep. 29, 2003; 60/543,735, filed on Jan. 22, 2004; 60/538,763, filed on Jan. 22, 2004; 60/538,915, filed on Jan. 22, 2004; and 60/538,767, filed on Jan. 22, 2004, which are hereby incorporated by reference in their entirety

### BACKGROUND

Increasing data store capacities are allowing for the storage of volumes of data that were once thought impossible to store. Such progress has availed the development of computing applications capable of processing and, alternatively, that rely on large amounts of data to offer desired features and operations. Nowhere, is the impact in the advancement of data storage capacities felt and observed than with Internet based applications. Current Internet based computing applications offer a number of features and operations including electronic commerce, electronic messaging, and information gathering and search. In the context of Internet search computing applications, none have been more prevalent than search portal type computing applications. Search portals offer to participating users the ability to search vast amounts of data for desired information with a few simple keystrokes and/or clicks of a mouse. From locating a person in Angola to finding the best price for a particular item, Internet search portal computing applications exploit increasing data storage capacities and search operations to offer participating users the information that they desire.

The search operations of Internet search portal computing applications may be premised on one or more search algorithms, data taxonomies, and/or search heuristics. In operation, one or more search queries are provided to a “search engine” of the search portal computing application. The “search engine” processes the queries according to one or more search algorithms and/or search heuristics to navigate the volumes of data in cooperating data stores that may be stored according to one or more data taxonomies. Upon navigating the voluminous data, the “search engine(s)” operate to provide the results of the search based on the inputted queries.

Given the large volumes of data that are searched, the “search engines” of Internet search portal computing applications are efficient and powerful. Capable of searching what may be terabytes worth of data, current search engines (and underlying search algorithms, data taxonomies, and search heuristics) are quick and responsive to inputted queries. However, because of their power, speed, and efficacy, these search engines generally are proprietary to the Internet search computing application service provider (e.g. Google, Yahoo!, Microsoft Search Network, etc.) and as such are not available for use general use (or in some instances customized and licensed use) outside of the Internet search computing application. Moreover, search engine developers and operators take preventive measures to ensure that the underlying technologies for their search operations are either kept secret or protected by governmental rights.

Comparatively, search features and operations found as part of personal computing environments or non-Internet networked computing environments are not as powerful as those found in Internet search computing applications, often leaving participating users employing such search features and operations waiting needlessly for desired search results. Moreover, current search features and operations are not integrated with Internet search computing applications such that participating users are required to perform multiple searches (e.g. a first search locally on a personal computing environment and second Internet search) leading to inefficiency of searches (e.g. wasted time and resources) and unreliability and inconsistency of searches (e.g. search terms may not be exactly carried over from one search to another).

Furthermore, computing application developers generally design and develop computing applications with an eye for future upgrades. From single function upgrades, to entire computing application upgrades wherein various features, functions, and appearance are upgraded, upgrades allow computing application developers to provide additional functionality/features without requiring the distribution/delivery of an entire new computing application. For certain computing applications, upgrades are necessary for proper operation and processing. For example, in the context of computing applications that calculate tax liabilities such computing applications require upgrade from year to year to reflect any and all changes to the tax code on which tax computing application relies when processing tax data. For other computing applications, upgrades allow for various benefits including, but not limited to, more efficient operation, more advanced features, better usability, and better presentation of data and operations/features to end users. A commonality with upgrades generally is that work on an existing computing application to provide these various benefits.

Conventional practices rely on the delivery and distribution of upgrades through fixed media (e.g., CD ROMs, DVDs, floppy disks). In this context, the upgrade to a computing application is loaded onto a computing environment having thereon a non-upgraded version of the computing application.

Another upgrade distribution and delivery mechanism that is currently employed relies on providing upgrades from a central server over a communications network to a computing environment seeking a computing application upgrade (e.g., Internet downloads and upgrades). In this context, the computing environment cooperates with the upgrade server to download and execute a particular upgrade (e.g., desired upgrade).

The upgrade, in some instances, can be a small computing application in itself that cooperates with the computing environment to identify the version of the computing application, the components that require upgrade, and modify, delete, or add the necessary components to provide the features/operations offered in the upgrade. However with current practices, it is often incumbent on the operator of the computing environment to periodically search for upgrades to computing applications. Such task is both time intensive and cumbersome as the computer operator may not be in an informed position to identify the source of such upgrades.

Some current practices provide computing applications that “automatically” upgrade (or provide to the computing environment operator the choice to upgrade) when a new upgrade becomes available. In such context, the computing environment operator is required to be connected to a communications network of some kind to retrieve the “automatic” upgrade. Such a requirement is both cumbersome and, in some instances, impractical (e.g., mobile computing environments). Additionally, with “automatic” upgrading computing applications there is no guarantee that the upgrade being provided to the computing application is being performed securely and is free from corruption. Furthermore, with current server-based upgrade practices, upgrades to popular computing applications can be timely as the upgrade servers are bogged with numerous simultaneous upgrade requests. Lastly, with current practices, computing environment operators are often having to guess which features/operations were upgraded, and more importantly, which modules of the computing application were changed, modified, deleted, or added. Without such revision history, computing environment operators are left in the position of being not completely informed about the details of a computing application.

### BRIEF SUMMARY

A mobility device operative within a mobility device platform offering search and/or upgrade operations and features portable across disparate computing environments is provided. In an illustrative implementation, a mobility device comprises at least one search and/or upgrade computing application that is operative with a plurality of computing environments. In the illustrative implementation, the search computing application is capable of searching for data or upgrading one or more computing application operating on the plurality of disparate computing environments. Additionally, in the illustrative implementation, the search engine comprises at least one of a search algorithm, data taxonomy structure, or search heuristics. Addition, in the illustrative implementation, the upgrade computing application comprises at least one of an upgrade algorithm or upgrade instruction data set.

In operation, the mobility device having the search and/or upgrade computing application cooperates with the plurality of disparate computing environments to execute the search and/or upgrade computing application. The search and/or upgrade computing application operates at least one computing application resident on the disparate computing environments to perform one or more searches and/or upgrade operations. In an illustrative implementation, the search and/or upgrade computing application is operative to search and/or upgrade a plurality of cooperating disparate computing environments.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 is a block diagram of an exemplary computing environment in accordance with an implementation of the herein described apparatus and methods;

FIG. 2 is a block diagram of an exemplary computing network environment in accordance with the herein described system and methods;

FIG. 3 is a block diagram showing the interaction between exemplary computing components in accordance with the herein described apparatus and methods;

FIG. 4 is a block diagram of an illustrative implementation of a mobility device platform in accordance with the herein described apparatus and methods;

FIG. 5A is a block diagram showing the interaction between exemplary search components in accordance with the herein described systems and methods;

FIG. 5B is a block diagram showing the interaction between exemplary upgrade components in accordance with the herein described systems and methods;

FIG. 6 is a flow diagram showing the processing performed to execute an illustrative search and/or computing application upgrade in accordance with the herein described systems and methods; and

FIG. 7 is a flow diagram showing the processing performed to execute another illustrative search and/or computing application upgrade in accordance with the herein described systems and methods.

### DETAILED DESCRIPTION

### Overview of Search

The herein described apparatus and methods leverage the capabilities of powerful search engines found in Internet search computing applications for use in personal computing and non-Internet networked computing environments. Current search computing applications are generally designed to operate on a singular computing environment. For example, in the context personal computing environments, the file management system of the personal computing environment may offer a search feature or operation that allows participating users to search for data (e.g. files or file structure—folders/subfolders) of the computing environment. Although operational, such search features are slow, cumbersome and cannot perform concurrent searches both on a local computing environment whilst searching other networked computing environments (e.g., the Internet).

### Overview of Upgrade

Upgrading computing applications can be achieved by distributing an upgrade to the computing application. Conventional practices rely on the distribution of computing application upgrades through fixed media (e.g., CD ROMS, DVDs, floppy disks, etc.). Such upgrade practice is inefficient and time intensive, often requiring the computing application operator to ferret around for the proper upgrade and/or to maintain a physical library of the fixed media upgrades. Conventional practices also provide computing applications having an automatic upgrade feature that often requires a connection to a communications network. In the context of automatic upgrades, typically, an upgrade computing server cooperates with the computing environment having the computing application requiring the “automatic upgrade” over a communications network. Although, such practice is more efficient (e.g., time and resource), it maintains a number of drawbacks including, but not limited to, not performing the upgrade over a secure communications link, not preventing corruption of the upgrade, and more importantly, the computing application requiring the upgrade, and inconsistent as the upgrade servers can be heavily taxed with concunent upgrade requests. Conventional practices also provide shortcomings when attempting to upgrade computing applications across an enterprise computing environment.

### Overview of Environment

For example, in the context of enterprise computing, the enterprise computing environment may comprise a number of server computing environments and numerous client computing environments. Generally, each user in the enterprise is provisioned client computing environment (e.g. personal computer or laptop computer) that is generally networked to the server computing environment through the enterprise communications interface or, if the user is remote to the enterprise communications network, through a virtual private network (VPN). Additionally, in conventional enterprise computing environments, the users are provided user identification information and password information through a directory services structure that associates user rights and privileges to certain enterprise data and computing applications.

With such enterprise computing environments, the user is often relegated to be only allowed to customize his/her provisioned computing environment with their preferences and settings such that if the user roams across the network and logs onto to a computing environment other than their own, they do not have access to their custom preferences and settings. This problem is also seen as enterprise users wishing to maintain synchronization in preferences and settings (e.g. browser bookmarks, look and feel of desktop, color scheme, layout of applications, and directory structure for files) between their enterprise computing environment and their personal computing environment (e.g. home computer) are often relegated to perform manual synchronization.

Moreover, with existing enterprise computing environments administration of the numerous client computing environments becomes a daunting task. Currently, enterprises hire information technology departments numbering in the tens, in not hundreds, to support the many users and their computing environments. Beyond mere physical administration, integrity and security of corporate data is put into play with the device-centric computing model. In such context, enterprise computing users are often left to their own volition in copying and comprising sensitive enterprise data. As the task of preventing users from unauthorized copying of enterprise files and data is daunting at best, most enterprises turn a blind eye. Such limitation of existing practices can be very costly to enterprises and individuals alike.

In an illustrative search implementation, an exemplary mobility device is provided containing thereon an exemplary search computing application. The exemplary search computing application may be similar or identical to an Internet-based search computing application such as GOOGLE®, YAHOO!®, or Microsoft Search Network (MSN®). The exemplary search computing application cooperates with the computing environment(s) operatively coupled to the mobility device to perform searches. In the illustrative implementation, the exemplary mobility device cooperates with a resident or wireless computing environment to launch the exemplary search computing application. In an illustrative operation, the exemplary search computing application cooperates with the operating system/platform of the cooperating computing environment to obtain information about local and networked directories, files, and data associated with and resident on the cooperating computing environment.

In the illustrative search operation, the exemplary search computing application can receive one or more search queries indicative of information sought to be retrieved from the local and/or networked directories, files, and data associated with and resident on the cooperating computing environment. The exemplary search computing application can employ one or more search algorithms, data taxonomies, search heuristics, and/or search protocols to locate a set of information that is responsive to the one or more search query. In this context, the exemplary search computing application can operate to perform the same or similar searches on local files and data as those performed by the powerful Internet search engines that are used in search portals similar to GOOGLE®, YAHOO!®, and MSN®.

In another illustrative search implementation, the exemplary mobility device can maintain a search computing application branded by an Internet search portal. In this context, the exemplary mobility device can operate to offer a mobile desktop computing environment that is branded by the Internet search portal's brands. In an illustrative implementation, the Internet search portal GOOGLE® can develop and distribute a client-based search computing application having the same or similar features of the Internet based search computing application. GOOGLE® can choose to distribute such client-based search computing application through the exemplary mobility device which also can support a mobile desktop environment employing web services technologies (as described above). In this implementation, the mobile desktop environment of the exemplary mobility device can be created so that the GOOGLE® brands are located throughout the mobility device mobile desktop environment. As such, the exemplary mobility device serves the purpose of offering both a client based search capacity, as well as a platform for which the search brand can be promoted.

In an illustrative upgrade implementation, an exemplary mobility device is provided containing thereon an exemplary upgrade computing application. The exemplary upgrade computing application may be similar or identical an upgrade computing application found in conventional practices (e.g., found on the fixed media upgrades or as provided by an upgrade server). The exemplary upgrade computing application cooperates with the computing environment(s) operatively coupled to the mobility device to perform upgrades on one or more computing applications. In the illustrative implementation, the exemplary mobility device cooperates with a resident or wireless computing environment to launch the exemplary upgrade computing application. In an illustrative operation, the exemplary upgrade computing application cooperates with the operating system/platform of the cooperating computing environment to obtain information about local and networked computing applications and data associated with and resident on the cooperating computing environment.

In the illustrative upgrade operation, the exemplary upgrade computing application can cooperate with the computing environment to identify which computing applications require upgrade. The exemplary upgrade computing application can employ one or more upgrade algorithms and/or upgrade heuristics to identify the computing applications requiring upgrade and to cooperate with such computing applications to provide the desired upgrade or upgrades. In this context, the exemplary upgrade computing application can operate to perform the same or similar upgrades on both local and networked computing applications performed by conventional upgrade practices. The exemplary upgrade computing application can further operate to store information about previous upgrades performed on the computing environment as well as maintain instructions to cooperatively communicate with one or more upgrade computing environments via a communications network to obtain new upgrades for installation on the cooperating computing environment.

In another illustrative implementation, the exemplary mobility device can maintain an upgrade computing application branded by a selected computing application provider (e.g., TurboTax®). In this context, the exemplary mobility device can operate to offer a mobile desktop computing environment that is branded by a selected computing application brands. In an illustrative implementation, the tax and accounting computing application developer INTUIT® can develop and distribute a client-based upgrade computing application having the same or similar features of the their server based upgrade practices. INTUIT® can choose to distribute such client-based upgrade computing application through the exemplary mobility device which also can support a mobile desktop environment employing web services technologies (as described above). In this implementation, the mobile desktop environment of the exemplary mobility device can be created so that the INTUIT® brands are located throughout.

### Web Services

Services provided over a communications network such as the Internet, commonly referred to as web services or application services, are evolving. Likewise, technologies that facilitate such services are also evolving. A web service can be defined as any information source running business logic processes conveniently packaged for use by an application or end user. Web services are increasingly becoming the means through which one can provide functionality over a network. Web services typically include some combination of programming and data that are made available from an application server for end users and other network-connected application programs. Web services range from such services as storage management and customer relationship management down to much more limited services such as the furnishing of a stock quote and the checking of bids for an auction item.

Activities focusing on defining and standardizing the use of web services include the development of Web Services Description Language (WSDL). WSDL is an Extensible Markup Language (XML) format for describing web services as a set of endpoints operating on messages containing either document-oriented or procedure-oriented information. The operations and messages are described abstractly, and then bound to a concrete network protocol and message format to define an endpoint. Related concrete endpoints are combined into abstract endpoints (services).

Currently, the advocated web service usage model is generally as follows.

(1) Services are implemented and deployed on one site, often referred to as the server side.
(2) Services are described using WSDL and are published via means such as UDDI (Universal Description, Discovery, and Integration), which is an XML-based registry for businesses worldwide to list themselves on the Internet by the web services they offer.
(3) Client applications use web services at another site, often referred to as the client side, by first interpreting one or more WSDL documents. Once interpreted, the clients can understand the characteristics of the associated service(s). For example, service characteristics may include service API specifications such as (a) input data type, (b) service input data format, (c) service access mechanism or style (e.g., RPC versus messaging), and (d) related encoding format.
(4) Client applications prepare their data in manners in which various particular web services understand.
(5) Client applications invoke a particular service according to the manner specified for the service, such as in an associated WSDL document.

Many differences exist among web services with respect to the format of input data and the manner in which they are invoked. For example, suppose one application service provider provides a service, getCityWeather, that requires a single input parameter, such as a conventional city name (e.g., SLC for Salt Lake City). A client application that intends to invoke such a service needs to be written so that data within or output by the application is able to be analyzed to extract the city information. At runtime, the prepared symbol is passed to the getCityWeather service site using appropriate APIs.

However, suppose another application service provider provides a similar service that requires two input parameters, such as the city name and the zip code. Hence, if a client application intends to invoke this second service, it needs to analyze and extract its data appropriately in regards to the required service input parameters. Therefore, if a single application was intended to invoke both services, the application would have to be hard-coded with service specific API information and procedures. Furthermore, if the application was intended to invoke numerous services, the application would have to be hard-coded with service-specific API information and procedures related to each and every service that it intended to invoke.

As explained above, various web services may provide similar functionality but differ in many ways. The herein described system and methods aim to ameliorate such disparity by offering a mobility device platform having a mobile device management server which includes, among other things, a web services translation module operative to accept data from web services web services providers and present them in a web service model native to cooperating mobility devices.

### Simple Object Access Protocol (SOAP) Overview:

The Simple Object Access Protocol (SOAP) is a lightweight, XML-based protocol for exchanging information in a decentralized, distributed environment. SOAP supports different styles of information exchange, including:

Remote Procedure Call style (RPC), which allows for request-response processing, where an endpoint receives a procedure oriented message and replies with a correlated response message.

Message-oriented information exchange, which supports organizations and applications that need to exchange business or other types of documents where a message is sent but the sender may not expect or wait for an immediate response.

Generally, a SOAP message consists of a SOAP envelope that encloses two data structures, the SOAP header and the SOAP body, and information about the name spaces used to define them. The header is optional; when present, it conveys information about the request defined in the SOAP body. For example, it might contain transactional, security, contextual, or user profile information. The body contains a Web Service request or reply to a request in XML format. The high-level structure of a SOAP message is shown in the following figure.

SOAP messages, when used to carry Web Service requests and responses, can conform to the web services definition language (WSDL) definition of available Web Services. WSDL can define the SOAP message used to access the Web Services, the protocols over which such SOAP messages can be exchanged, and the Internet locations where these Web Services can be accessed. The WSDL descriptors can reside in UDDI or other directory services, and they can also be provided via configuration or other means such as in the body of SOAP request replies.

There is a SOAP specification (e.g. w3 SOAP specification—found at www.w3.org) that provides a standard way to encode requests and responses. It describes the structure and data types of message payloads using XML Schema. The way that SOAP may be used for the message and response of a Web Service is:

The SOAP client uses an XML document that conforms to the SOAP specification and which contains a request for the service.

The SOAP client sends the document to a SOAP server, and the SOAP servlet running on the server handles the document using, for example, HTTP or HTTPS.

The Web service receives the SOAP message, and dispatches the message as a service invocation to the application providing the requested service.

A response from the service is returned to the SOAP server, again using the SOAP protocol, and this message is returned to the originating SOAP client.

It is appreciated that although SOAP is described herein as a communication protocol for the herein described apparatus and methods that such description is merely illustrative as the herein described apparatus and methods may employ various communication protocols and messaging standards.

### Illustrative Computing Environment

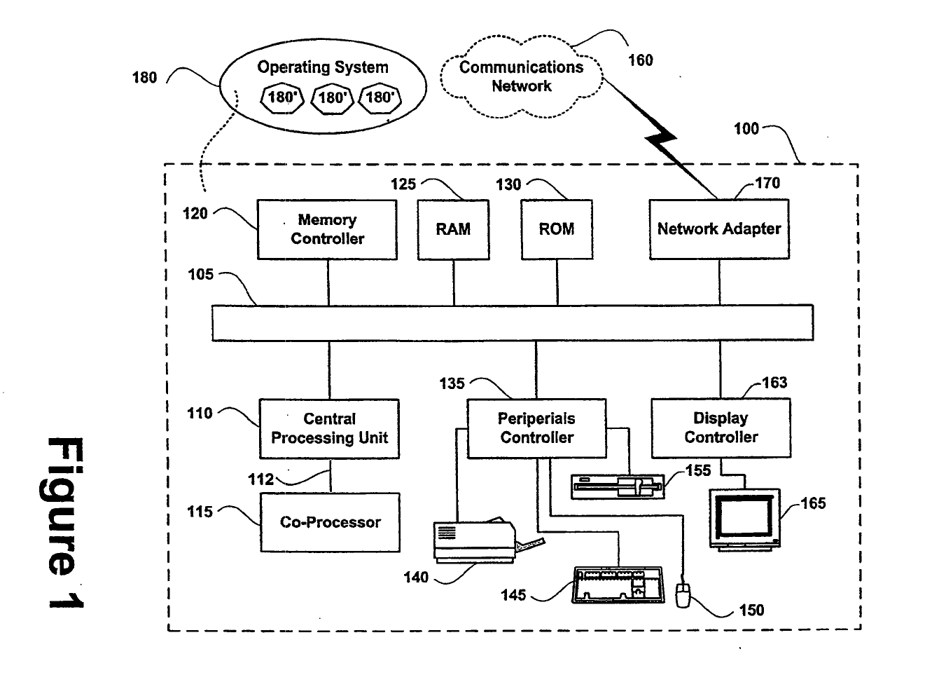

FIG. 1 depicts an exemplary computing system 100 in accordance with herein described system and methods. Computing system 100 is capable of executing a variety of operating systems 180 and computing applications 180′ (e.g. web browser and mobile desktop environment) operable on operating system 180. Exemplary computing system 100 is controlled primarily by computer readable instructions, which may be in the form of software, where and how such software is stored or accessed. Such software may be executed within central processing unit (CPU) 110 to cause data processing system 100 to do work. In many known computer servers, workstations and personal computers central processing unit 110 is implemented by micro-electronic chips CPUs called microprocessors. Coprocessor 115 is an optional processor, distinct from main CPU 110, that performs additional functions or assists CPU 110. CPU 110 may be connected to co-processor 115 through interconnect 112. One common type of coprocessor is the floating-point coprocessor, also called a numeric or math coprocessor, which is designed to perform numeric calculations faster and better than general-purpose CPU 110.

It is appreciated that although an illustrative computing environment is shown to comprise a single CPU 110 that such description is merely illustrative as computing environment 100 may comprise a number of CPUs 110. Additionally computing environment 100 may exploit the resources of remote CPUs (not shown) through communications network 160 or some other data communications means (not shown).

In operation, CPU 110 fetches, decodes, and executes instructions, and transfers information to and from other resources via the computer's main data-transfer path, system bus 105. Such a system bus connects the components in computing system 100 and defines the medium for data exchange. System bus 105 typically includes data lines for sending data, address lines for sending addresses, and control lines for sending interrupts and for operating the system bus. An example of such a system bus is the PCI (Peripheral Component Interconnect) bus. Some of today's advanced busses provide a function called bus arbitration that regulates access to the bus by extension cards, controllers, and CPU 110. Devices that attach to these busses and arbitrate to take over the bus are called bus masters. Bus master support also allows multiprocessor configurations of the busses to be created by the addition of bus master adapters containing a processor and its support chips.

Memory devices coupled to system bus 105 include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process's virtual address space unless memory sharing between the processes has been set up.

In addition, computing system 100 may contain peripherals controller 135 responsible for communicating instructions from CPU 110 to peripherals, such as, printer 140, keyboard 145, mouse 150, and data storage drive 155.

Display 165, which is controlled by display controller 163, is used to display visual output generated by computing system 100. Such visual output may include text, graphics, animated graphics, and video. Display 165 may be implemented with a CRT-based video display, an LCD-based flat-panel display, gas plasma-based flat-panel display, a touch-panel, or other display forms. Display controller 163 includes electronic components required to generate a video signal that is sent to display 165.

Further, computing system 100 may contain network adaptor 170 which may be used to connect computing system 100 to an external communication network 160. Communications network 160 may provide computer users with means of communicating and transferring software and information electronically. Additionally, communications network 160 may provide distributed processing, which involves several computers and the sharing of workloads or cooperative efforts in performing a task. It will be appreciated that the network connections shown are exemplary and other means of establishing a communications link between the computers may be used.

It is appreciated that exemplary computer system 100 is merely illustrative of a computing environment in which the herein described apparatus and methods may operate and does not limit the implementation of the herein described apparatus and methods in computing environments having differing components and configurations as the inventive concepts described herein may be implemented in various computing environments having various components and configurations.

### Illustrative Computer Network Environment:

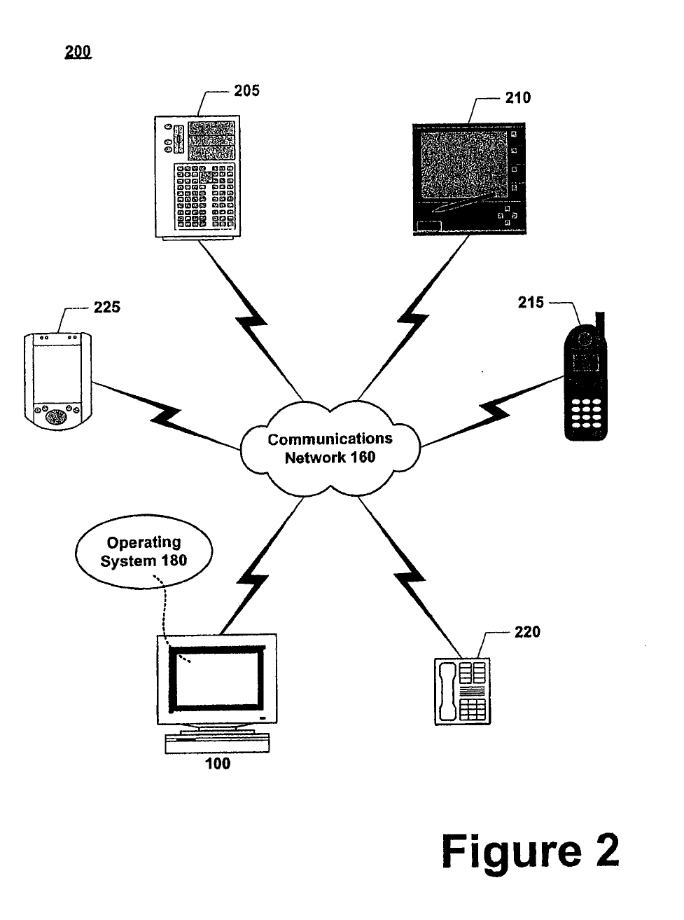

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2 server 205 may be interconnected via a communications network 160 (which may be either of, or a combination of a fixed-wire or wireless LAN, WAN, intranet, extranet, peer-to-peer network, the Internet, or other communications network) with a number of client computing environments such as tablet personal computer 210, mobile telephone 215, telephone 220, personal computer 100, and personal digital assistance 225. Additionally, the herein described apparatus and methods may cooperate with automotive computing environments (not shown), consumer electronic computing environments (not shown), and building automated control computing environments (not shown) via communications network 160. In a network environment in which the communications network 160 is the Internet, for example, server 205 can be dedicated computing environment servers operable to process and communicate web services to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Each client computing environment 100, 210, 215, 220, and 225 can be equipped with browser operating system 180 operable to support one or more computing applications such as a web browser (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205 using web services transactions. These web services transactions may be communicated between client computing environments 100, 210, 215, 220, and 220 and server computing environments for processing and storage. Server computing environment 205 may host computing applications, processes and applets for the generation, authentication, encryption, and communication of web services and may cooperate with other server computing environments (not shown), third party service providers (not shown), network attached storage (NAS) and storage area networks (SAN) to realize such web services transactions.

Thus, the apparatus and methods described herein can be utilized in a computer network environment having client computing environments for accessing and interacting with the network and a server computing environment for interacting with client computing environments. However, the apparatus and methods providing the mobility device platform can be implemented with a variety of network-based architectures, and thus should not be limited to the example shown. The herein described apparatus and methods will now be described in more detail with reference to a presently illustrative implementation.

### Mobility Device Platform Components:

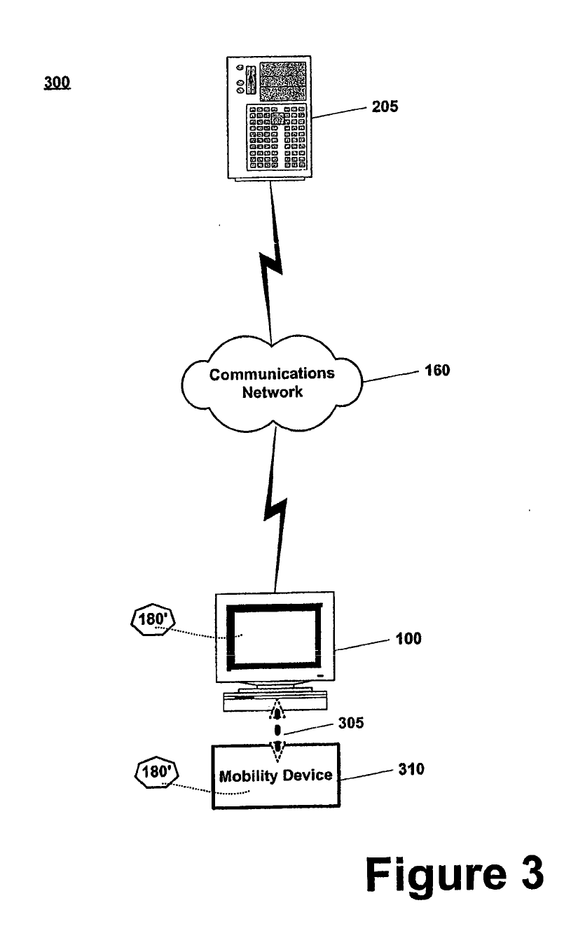

FIG. 3 shows an exemplary interaction between an exemplary mobility device and an illustrative mobility device platform. Generally as is shown in FIG. 3, exemplary mobility device platform 300, in simple terms, may comprise mobility device 310 cooperating with client computing environment 100 using communications interface 305 operating on a selected communications protocol (not shown). Additionally, exemplary mobility device platform 300 may further comprise communications network 160 (of FIG. 1) and server computing environment 205.

In operation mobility device may cooperate with client computing environment 100 through communications interface 305 to execute one or more computing applications 180′ originating from mobility device 310 and displayable for user interaction on client computing environment 100. Computing applications 180′ may include but are not limited to, a browser application offering the look and feel of conventional operating systems, word processing applications, spreadsheets, database applications, web services applications, and user management/preference applications. Additionally, mobility device 310 may cooperate with server computing environment 205 via communications network 160 using client computing environment 100 to obtain data and/or computing applications in the form of web services.

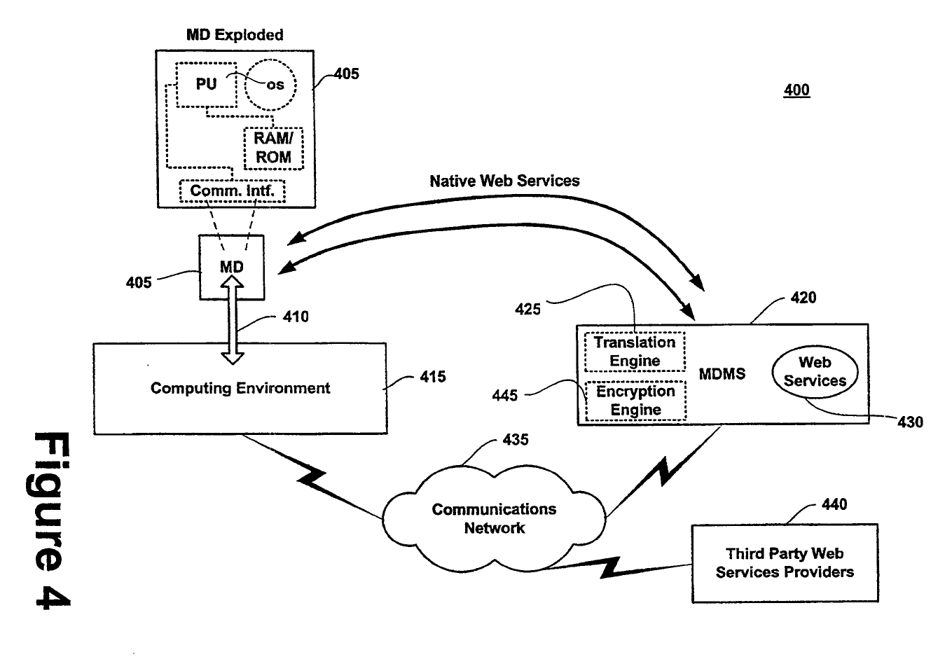

FIG. 4 shows the interplay of exemplary mobility device 405 with illustrative mobility device platform 400. As is shown in FIG. 4, exemplary mobility device platform 400 comprises mobility device (MD) 405, computing environment 410, communications network 435, mobility device management server (MDMS) 420 and third party web service providers 440. Additionally, as is further shown in the MD exploded view, MD 405 further comprises processing unit (PU), operating system (OS), storage memory (RAM/ROM), and an MD communications interface. Also, MDMS 420 further comprises translation engine 425, web services 430, and encryption engine 445.

In operation, MD 405 communicates with computing environment 415 using one or more of MD components PU, OS, RAM/ROM and MD communications interface through MD/computing environment communications interface 410. When communicating with computing environment 415, MD 405 may launch one or more computing applications (not shown) that may include but are not limited to, a mobile desktop environment, user customization and authentication manager, and web services applications as part of configuration. Once configured, MD 405 may further cooperate with computing environment 415 to process one or more web services (e.g. web service data and/or computing applications). In such context, MD 405 may also request web services data and/or computing applications from cooperating MDMS 420 using communications network 435 to process such web services. In such instance, MDMS 420 may operate to authenticate MD 405 to ensure that the participating user (not shown) and mobility device 405 have the correct privileges to the requested data and/or computing applications.

If properly authenticated, MDMS 420 may further operate to locate the requested data and/or computing applications locally at MDMS 420 and provide such requested data and/or computing applications (e.g. web services) to the authenticate MD 405 over communications network 435, or operate to cooperate with third party services providers 440 to obtain the requested web services for communication to the authenticated MD 405. When cooperating with third party web services providers 440, MDMS 420 may operate to translate the web services 430 originating from third party web services providers 440 to an MD native format using translation engine 425. Additionally, MDMS 420 may operate to encrypt requested web services using encryption engine 445 when satisfying requests for web services from authenticated MD 405.

Additionally, MDMS 420 may further operate to cooperate with a file system (not shown) using a selected encryption protocol (e.g. PKI encryption) to obtain the requested data for communication to MD 405. The cooperating file system may include but is not limited to file allocation table (FAT) file systems and new technology files system (NTFS).

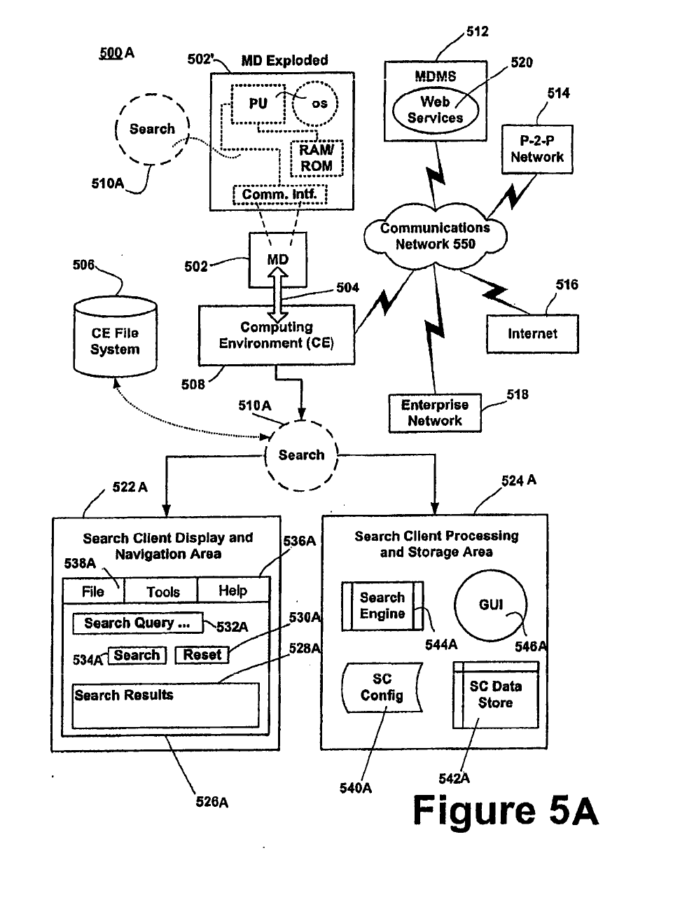

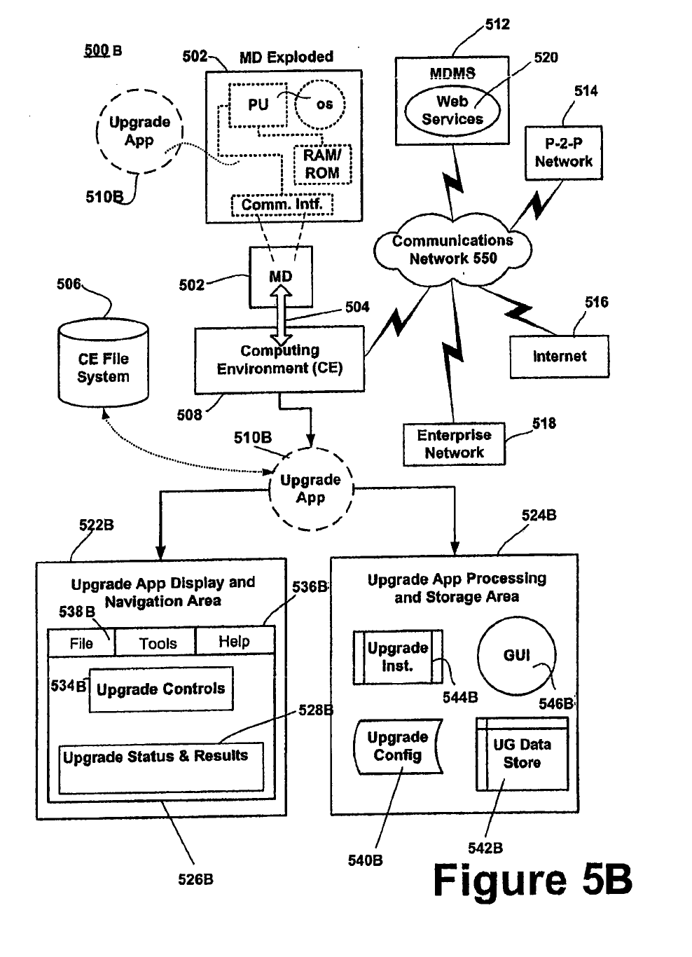

FIG. 5A shows a block diagram of the exemplary components in an illustrative search implementation of the herein described systems and methods to realize a mobility device search client. As is shown exemplary mobility computing environment 500 comprises mobility device (MD) 502 that cooperates with computing environment (CE) 508. As is further shown, in the MD exploded view 502′, MD 502 can comprises a number of components including but not limited to a processing unit (PU), an operating system (OS), memory (RAM/ROM), and a communication interface (Comm. Intf.). Additionally, as is shown, MD 502 can support and execute search computing application 510A which is operable on the computing environment file system 506 and to search other networked data resident on one or more cooperating networked computing environments including but not limited to MDMS 512 operating web services 520, P-2-P network 514, the Internet 516, and enterprise network 516 over communications network 550.

Additionally as is shown, search client computing application 510A can comprise search client display and navigation area 522A and search client processing and storage area 524A. Search client display and navigation area 522 can be employed to display information representative of search client search queries and/or search client search results on display application 536A. As is shown, display application (e.g., browser computing application) can comprise navigation controls 538A, search client controls 534A and 530A, input fields 532A and search result dialog pane 526A.

Search client processing and storage area 524A of search client computing application 510A can comprise search engine 544A which can be configured according to one or more search client configuration parameters 530A. Additionally, search client processing and storage area 524A can comprise instructions for displaying search data and graphical information (e.g., GUI definition) 546A, and maintain search client data store 542A that can be used to store search client data.

In operation, search client mobility device 502 cooperates with CE 508 over communications interface 504 to launch and execute search client computing application 510A. Search client computing application 510A is operable to perform one or more searches for data on CE file system 506 through CE 508 or through other networked computing environments (e.g., MDMS 512 using web services 520, P-2-P Network 514, the Internet 516, and enterprise network 518) over communications network 550. When performing searches, search client computing application 510A can receive search queries through input fields 532A and manipulated by a participating user (not shown) through the use of navigation controls 538A and search client controls 532A and 534A of search client display and navigation area 522A. Such queries can be processed by search client computing application according to search engine 544A of search client processing and storage area 524A using search client configuration parameters 540A. Search engine 544A can operate to process the search query according to one or more search rules, protocols, heuristics, and/or instructions (not shown) to retrieve data from CE file system 506 and/or one or more of the networked computing environments (e.g., MDMS 512 using web services 520, P-2-P Network 514, the Internet 516, and enterprise network 518).

It is appreciated that in context of MDMS 512 operating web services 520, search client mobility device 502 can be required to be authenticated so that it can access the data and features offered by MDMS 512. In such context, a secure search platform can be assembled to allow for the secure search and communication of data using mobility device search client 502.

FIG. 5B shows a block diagram of the exemplary components in an illustrative upgrade implementation of the herein described systems and methods to realize a mobility device upgrade module. As is shown exemplary mobility computing environment 500 comprises mobility device (MD) 502 that cooperates with computing environment (CE) 508. As is further shown, in the MD exploded view 502′, MD 502 can comprises a number of components including but not limited to a processing unit (PU), an operating system (OS), memory (RAM/ROM), and a communication interface (Comm. Intf.). Additionally, as is shown, MD 502 can support and execute upgrade computing application 510B which is operable to perform upgrades on computing applications resident on the computing environment file system 506 and to perform upgrades on other networked computing applications resident on one or more cooperating networked computing environments including but not limited to MDMS 512 operating web services 520, P2-P network 514, the Internet 516, and enterprise network 516 over communications network 550.

Additionally as is shown, upgrade client computing application 510B can comprise upgrade application display and navigation area 522B and upgrade application processing and storage area 524B. Upgrade application display and navigation area 522B can be employed to display information representative of an upgrade to one or more local and/or networked computing applications on display pane 536B. As is shown, display pane (e.g., browser computing application) can comprise navigation controls 538B, upgrade client controls 534B, and search result dialog pane 526B.

Upgrade application processing and storage area 524B of upgrade computing application 510B can comprise upgrade instructions 544B which can be configured according to one or more upgrade application configuration parameters 530B. Additionally, upgrade application processing and storage area 524B can comprise instructions for displaying upgrade data and graphical information (e.g., Gill definition) 546B, and maintain upgrade data store 542B that can be used to store upgrade data.

In operation, mobility device 502 cooperates with CE 508 over communications interface 504 to launch and execute upgrade computing application 510B. Upgrade computing application 510B is operable to perform one or more upgrades on computing applications resident on CE file system 506 through CE 508 or through other networked computing environments (e.g., MDMS 512 using web services 520, P-2-P Network 514, the Internet 516, and enterprise network 518B) over communications network 550. When performing upgrades, upgrade computing application 510B can receive requests for upgrades or notify computing environment 508 operators (not shown) of scheduled upgrade on upgrade application display and navigation area 522B. Additionally, such upgrade information can be manipulated by a participating user (not shown) through the use of navigation controls 538B and upgrade controls 534B of upgrade application display and navigation area 522B. Upgrade requests can be processed by upgrade computing application according to upgrade instructions 544B of upgrade application processing and storage area 524B using upgrade configuration parameters 540B. Upgrade instructions 544B can operate to process the upgrade request according to one or more upgrade protocols, heuristics, and/or instructions (not shown) to cooperate with computing applications resident on the CE file system 506 and/or one or more of the networked computing environments (e.g., MDMS 512 using web services 520, P-2-P Network 514, the Internet 516, and enterprise network 518).

It is appreciated that in context of MDMS 512 operating web services 520, mobility device upgrade module 502 can be required to be authenticated so that it can access the data and features offered by MDMS 512. In such context, a secure search platform can be assembled to allow for the secure upgrade and communication of upgrade data using mobility device upgrade module 502.

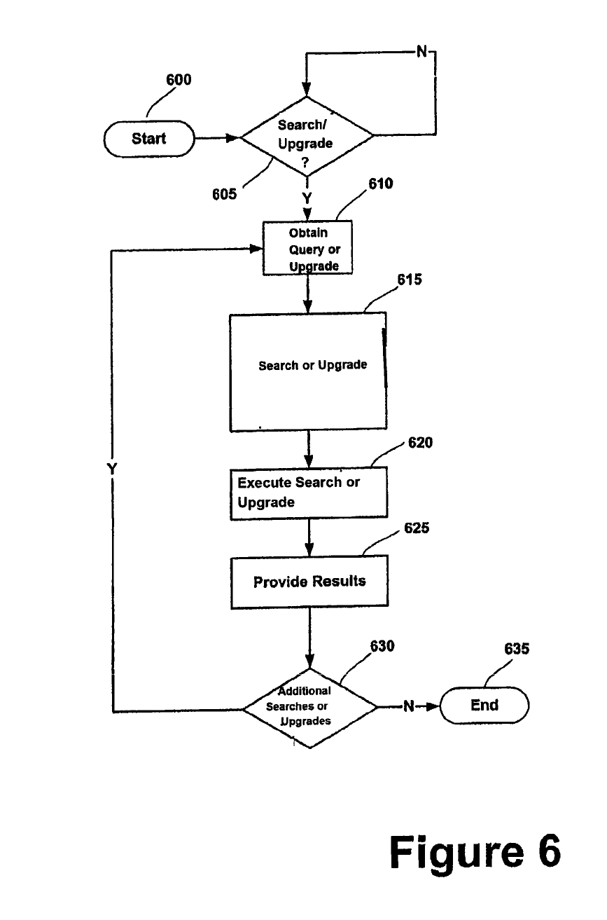

FIG. 6 shows the processing performed when executing a search or an upgrade using mobility device search client or mobility device upgrade module (both referred to as element 502 in FIGS. 5A and 5B. As is shown, processing begins at block 600 and proceeds to block 605 where a check is performed to determine if a search or an upgrade has been requested. If a search or an upgrade has not been requested, processing reverts back to the input of block 605. However, if at block 605 it is determined that a search or an upgrade has been requested, processing proceeds to block 610 where a search query or an upgrade, respectively is obtained.

From there processing proceeds to block 615 where a selected search or upgrade protocol (respectively) according to a selected heuristic is applied to data (if a search) or (not shown—of an upgrade) to satisfy the received search query or upgrade request, respectively. If a search, the then performed using the query at block 620. If an upgrade, the upgrade is performed at block 620. The results of the search or upgrade are then provided at block 625.

From there a check is performed to determine if an additional search or upgrade is to be performed. If an additional search or is to be performed, as determined by the check at block 630, processing reverts to block 610 and proceeds from there. However, if the check at block 630 indicates that an additional search or upgrade is not to be performed, processing terminates at block 635.

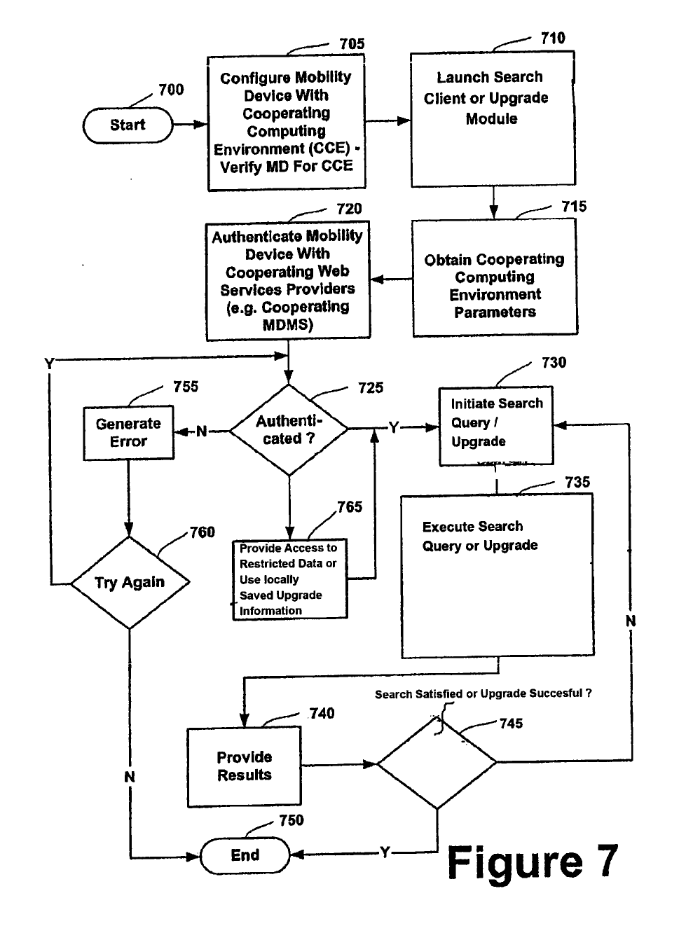

FIG. 7 shows the processing performed when employing an exemplary mobility device search client or upgrade module as part of a mobility device platform. As is shown, processing begins at block 700 and proceeds to block 705 where the mobility device is configured with the cooperating computing environment (CCE) to verify a mobility device with the CCE.

From there, processing proceeds to block 710 where the search client or upgrade computing application resident on the mobility device is launched and the search client or upgrade computing application configuration parameters are applied to the search client or upgrade computing application, respectively.

The mobility device is then configured to obtain cooperating computing environment parameters at block 715. The mobility device search client or upgrade module is then authenticated with cooperating web services providers (e.g., cooperating MDMS') at block 720.

A check is then performed at block 725 to determine if the mobility device search client or upgrade module was properly authenticated. If the check at block 725 indicates that the mobility device search client or upgrade module was properly authenticated (e.g., with one or more cooperating web services), processing block 730 is initiated in which (in the case of a search) a search query is obtained, or (in the case of an upgrade), an upgrade to one or more computing applications is initiated.

From there processing proceeds to block 735 where (in the case of a search) the search query is executed by the search client according to a selected search protocol that can be based on a selected search heuristic for local data if so restricted at block 725 or if authenticated with cooperating web services (e.g., corporate terminal session, online banking, etc.). In the case of an upgrade, the upgrade is executed by the upgrade module according to a selected upgrade instruction set that can be based on a selected update heuristic for local data if so restricted at block 725 or if authenticated with cooperating web services (e.g., corporate terminal session, online banking, etc.).

From there processing proceeds to block 740 where the results of the search or query upgrade are provided. A check is then performed at block 745 to determine if the search was satisfied or the upgrade was successful. If the check at block 745 indicates that the search was satisfied or upgrade was successful, processing terminates at block 750. However, if the check at block 745 indicates that the search was not satisfied or the upgrade was not successful, processing reverts back to block 730 and proceeds from there.

However if at block 725, it is determined that the mobility device search client or upgrade module was not properly authenticated, processing splits and proceeds to block 755 where an error is generated and to block 765 where the search or upgrade is restricted to a local computing environment search or upgrade.

From block 755 processing proceeds to block 760 where a check is performed to determine if the authentication is to be attempted again. If authentication is to be attempted again, processing reverts back to block 725 and proceeds from there. However, if at block 760, it is determined that authentication is not be attempted again, processing terminates at block 750. From block 765, processing proceeds to block 730 and proceeds from there as described above.

In sum, the herein described apparatus and methods provide a mobility device for use as a search client or an upgrade module. It is understood, however, that the invention is susceptible to various modifications and alternative constructions. There is no intention to limit the invention to the specific constructions described herein. On the contrary, the invention is intended to cover all modifications, alternative constructions, and equivalents falling within the scope and spirit of the invention.

What is claimed is:

1. A mobility device for connecting to at least one separate cooperating computing environment to perform a search on data stored on the at least one separate cooperating computing environment, the mobility device comprising:
a communications interface for connecting the mobility device to any of a plurality of different computing devices;
at least one of a search computing application and an upgrade computing application;
an operating system; and
a processing unit that, when the mobility device is connected via the communication interface to any of the plurality of different computing devices, executes the search computing application or the upgrade computing application.

2. The mobility device as recited in claim 1, wherein the search computing application is for performing a search, via the communications interface, of data stored in a file system of the connected computing device.

3. The mobility device as recited in claim 3 further comprising a memory storage area operable to store searches and search configuration data.

4. The mobility device as recited in claim 2 further comprising a peripheral interface module operative to accept and cooperate with peripherals comprising any of: flash memory, communications interface, automation control peripherals and input peripherals.

5. The mobility device as recited in claim 2 further comprising NAND flash memory operatively coupled to the processing unit and utilized as part of web services processing.

6. The mobility device as recited in claim 2 further comprising a mobile desktop computing application operable to present a desktop computing environment on a computing device when the mobility device is connected to the computing device via the communications interface.

7. The mobility device as recited in claim 6 further comprising a user management module operable to customize participating users preferences and settings for the mobility device.

8. The mobility device as recited in claim 2 further comprising an auto-run module that performs auto-configuration of a computing device when the mobility device is connected to the computing device.

9. The mobility device as recited in claim 8 wherein the computing device comprises an operating system native to the computing device.

10. The mobility device as recited in claim 9 wherein the operating system of the mobility device controls the operating system native to the computing device.

11. The mobility device as recited in claim 10 further comprising a user authentication and management module operative to authenticate a participating user with the mobility device using user authentication information.

12. The mobility device as recited in claim 2 further comprising a mobility device platform authentication and verification module operative to authenticate the mobility device with a cooperating mobility device management server.

13. The mobility device as recited in claim 12 wherein the mobility device cooperates with the mobility device management server to obtain web services comprising any of search features and data storage features.

14. The mobility device as recited in claim 13 wherein the mobility device management server provides web services to the mobility device upon authenticating the mobility device.

15. The mobility device as recited in claim 2 further comprising a math co-processor cooperating with the processing unit to process web services.

16. The mobility device as recited in claim 15 further comprising an encryption module for use to encrypt and decrypt web services transactions.

17. The mobility device as recited in claim 2 wherein the operating system comprises a java virtual machine (JVM) operable to execute various computing applications.

18. The mobility device as recited in claim 17 wherein the computing applications comprise any of an e-mail computing application, a word processor computing application, a browser computing application, a mobile desktop environment, a spread sheet computing application, search client computing application and other computing applications that may be presented as web services.

19. The mobility device as recited in claim 18 further comprising a work space module operative to allow the operation of a plurality of work spaces on the mobility device.

20. The mobility device as recited in claim 1 wherein the processing unit executes the search computing application to perform the search on data stored remotely over the internet, such that the search computing application searches data stored both locally and remotely to the connected computing device simultaneously.
